(19) United States
(12) Patent Application Publication
(10) Pub. No.: US 2019/0068006 A1
(43) Pub. Date: Feb. 28, 2019

(54) MOBILE TERMINAL AND SYSTEM

(71) Applicant: KYOCERA Corporation, Kyoto-shi (JP)

(72) Inventor: Ikuho IKEDA, Yokohama-shi (JP)

(21) Appl. No.: 16/108,224

(22) Filed: Aug. 22, 2018

(30) Foreign Application Priority Data
Aug. 23, 2017 (JP) 2017-160541

(51) Int. Cl. H02J 50/90; H02J 7/00; H04W 4/02; G08B 21/18

(52) U.S. Cl. CPC H02J 50/90; G08B 21/182; H04W 4/023; H02J 7/0047

(57) ABSTRACT

A mobile terminal includes an operation part, a communication unit, a display, a speaker, a receiver, and a controller. The controller is configured to switch an operation mode of the mobile terminal from a first mode to a second mode, if detecting placement of the mobile terminal in a charging stand, output a warning sound on the basis of operation from the operation part in the first mode, and output no warning sound even though receiving operation from the operation part in the second mode.

### CROSS-REFERENCE TO RELATED APPLICATION(S)

The present application claims priority under 35 U.S.C. § 119 to Japanese Patent Application No. 2017-160541 filed on Aug. 23, 2017, entitled “MOBILE TERMINAL AND SYSTEM”. The content of which is incorporated by reference herein in its entirety.

### FIELD

Embodiments of the present disclosure relate to a mobile terminal and a system.

### BACKGROUND

Conventionally, to ensure safety or the like of little children or school children, mobile phone devices having a crime prevention effect are provided. Each of the mobile phone devices is configured so that when a user performs specific operation, a crime prevention buzzer makes a sound, and current locational information is automatically transmitted to a predetermined address.

### SUMMARY

It is an object of the present disclosure to at least partially solve the problems in the conventional technology.

A mobile terminal according to one embodiment includes an operation part, a communication unit, a display, a speaker, a receiver, and a controller. The controller is configured to switch an operation mode of the mobile terminal from a first mode to a second mode, if detecting placement of the mobile terminal in a charging stand, output a warning sound on the basis of operation from the operation part in the first mode, and output no warning sound even though receiving operation from the operation part in the second mode.

A system according to one embodiment includes a mobile terminal, a charging stand, and other terminal. The mobile terminal includes a communication unit, and a controller. The controller is configured to perform notification of detection of placement of the mobile terminal in the charging stand, to the other terminal via the communication unit.

The above and other objects, features, advantages and technical and industrial significance of this disclosure will be better understood by reading the following detailed description of presently preferred embodiments of the invention, when considered in connection with the accompanying drawings.

### BRIEF DESCRIPTION OF THE DRAWINGS

FIG. 1 is an exemplary view of appearance of a mobile terminal according to an embodiment;

FIG. 2 is an exemplary view of appearance of a mobile terminal according to an embodiment placed in a charging stand;

FIG. 3 is an overview of a system configuration according to an embodiment;

FIG. 4 is an exemplary block diagram of a functional configuration of a mobile terminal according to an embodiment;

FIG. 5 is a diagram illustrating an overview of a configuration of a home application data according to an embodiment;

FIG. 6 is an exemplary diagram of a notification setting table according to an embodiment;

FIG. 7 is an exemplary table of a group terminal data according to an embodiment;

FIG. 8 is an exemplary table of a group terminal location data according to an embodiment;

FIG. 9 is an exemplary block diagram of a functional configuration of a charging stand according to an embodiment;

FIG. 10 is an exemplary flowchart illustrating a process performed by a mobile terminal according to an embodiment;

FIG. 11 is a diagram illustrating exemplary display of a character image according to an embodiment;

FIG. 12 is an exemplary flowchart illustrating a process performed by a mobile terminal according to an embodiment;

FIG. 13 is an exemplary flowchart illustrating a process performed by a mobile terminal according to an embodiment;

FIG. 14 is an exemplary flowchart illustrating a process performed by a mobile terminal according to an embodiment;

FIG. 15 is an exemplary flowchart illustrating a process performed by a mobile terminal according to an embodiment;

FIG. 16 is a diagram illustrating exemplary display of a location display image according to an embodiment;

FIG. 17 is an exemplary flowchart illustrating a process performed by a mobile terminal according to an embodiment;

FIG. 18 is an exemplary flowchart illustrating a process performed by a mobile terminal according to an embodiment; and

FIG. 19 is an exemplary flowchart illustrating a process performed by a mobile terminal according to an embodiment.

### DETAILED DESCRIPTION

Embodiments according to the present application will be described in detail with reference to the drawings. In the following description, the same component elements may be decoded by the same reference signs. In addition, repeated description may be omitted. In the conventional technology, there may be room for enhancing functions and improving users' convenience from the viewpoint of the parents or guardians taking care of their children and from the viewpoint of the children taken care of by the parents or guardians.

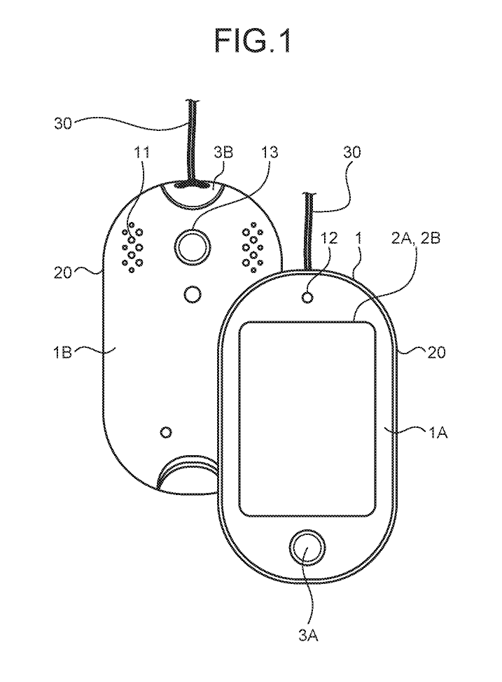

FIG. 1 is an exemplary view of appearance of a mobile terminal according to an embodiment. As illustrated in FIG. 1, a mobile terminal 1 includes a housing 20. The housing 20 includes a front face 1A and a back face 1B. The front face 1A is a front side of the mobile terminal 1 facing a user who uses the mobile terminal 1. The back face 1B is a back side of the mobile terminal 1. The back face 1B has a curved surface gently inclining from the center of the surface thereof to an edge connected to the front face 1A.

The mobile terminal 1 includes a display 2A, a touch screen 2B, a home key 3A, and a camera (in-camera) 12 on the front face 1A. The mobile terminal 1 includes a buzzer switch 3B, a speaker 11, and a camera (out-camera) 13.

In the example of FIG. 1, the display 2A and the touch screen 2B have a substantially rectangular shape, but the shapes of the display 2A and the touch screen 2B are not limited to the rectangular shape. Each of the display 2A and the touch screen 2B may have any shape, such as a square shape or a circular shape. In the example of FIG. 1, the display 2A and the touch screen 2B are arranged to be overlaid on each other, but arrangement of the display 2A and the touch screen 2B is not limited to this arrangement. The display 2A and the touch screen 2B may be arranged, for example, side by side or separately from each other. In the example of FIG. 1, the display 2A has a long side extending along a long side of the touch screen 2B, and the display 2A has a short side extending along a short side of the touch screen 2B, but overlaying of the display 2A and the touch screen 2B is not limited to this description. When the display 2A and the touch screen 2B are overlaid on each other, for example, one or a plurality of sides of the display 2A may not extend along any side of the touch screen 2B.

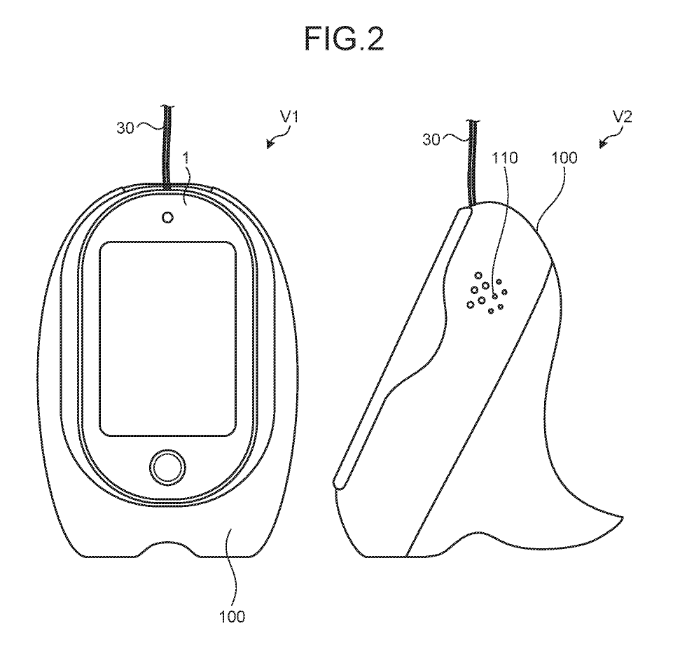

FIG. 2 is an exemplary view of appearance of a mobile terminal according to an embodiment placed in a charging stand. FIG. 2 illustrates a front view V1 and a right side view V2 of the mobile terminal 1 placed in a charging stand 100 dedicated for the mobile terminal 1. As illustrated in FIG. 2, the mobile terminal 1 is tightly fitted into the charging stand 100, for example, during charging. The mobile terminal 1 being placed in the charging stand 100 is allowed to output a warning sound when a strap 30 is operated to turn on the buzzer switch 3B. The mobile terminal 1 being placed in the charging stand 100 is also allowed to output a ringtone, a voice during a call, an alarm sound, a warning sound, and the like from a speaker 110 of the charging stand 100.

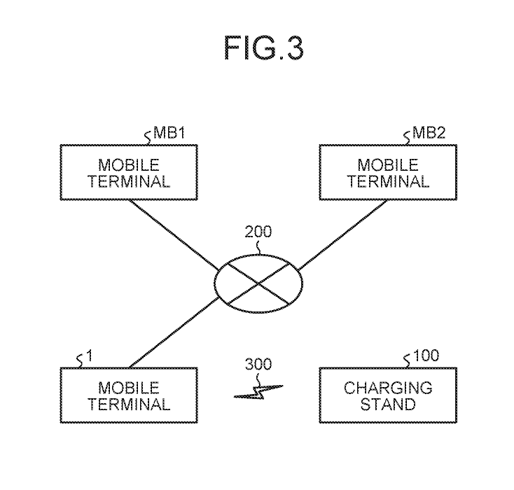

FIG. 3 is an overview of a system configuration according to an embodiment. As illustrated in FIG. 3, the mobile terminal 1 is configured to communicate with a mobile terminal MB1 and a mobile terminal MB2 via a communication network 200. In an example of a preferred use condition of the system, it is conceivable that a child uses the mobile terminal 1 and parents of the child use the mobile terminal MB1 and the mobile terminal MB2. The communication network 200 includes the Internet and a mobile phone network. The mobile terminal 1 is communicably connected to the charging stand 100 via a wireless communication network 300. The wireless communication network 300 employs near field communication such as Bluetooth (trade mark).

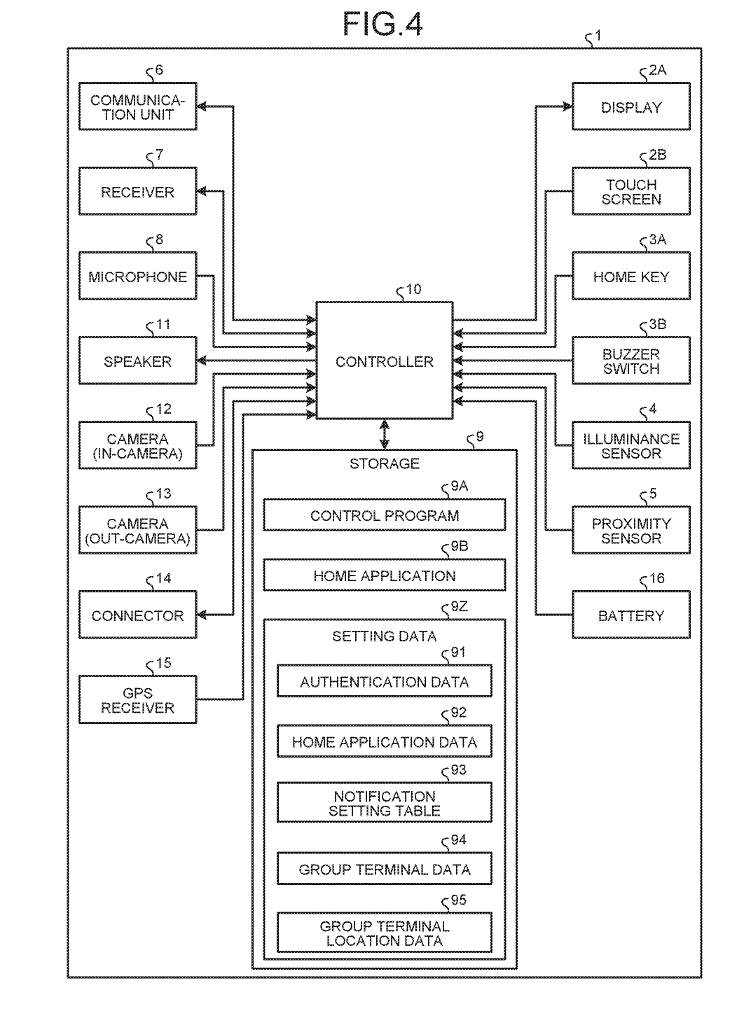

FIG. 4 is an exemplary block diagram of a functional configuration the mobile terminal 1 according to an embodiment. In the following description, the same component elements may be decoded by the same reference signs. In the following description, repeated description may be omitted.

As illustrated in FIG. 4, the mobile terminal 1 includes the display 2A, the touch screen 2B, the home key 3A, the buzzer switch 3B, an illuminance sensor 4, a proximity sensor 5, a communication unit 6, a receiver 7, a microphone 8, a storage 9, a controller 10, the speaker 11, the camera (in-camera) 12, the camera (out-camera) 13, a connector 14, a GPS receiver 15, and a battery 16.

The display 2A includes a display device, such as a liquid crystal display (LCD), an organic electro-luminescence display (OELD), or an inorganic electro-luminescence display (IELD). The display 2A displays an object, such as letters, an image, a symbol, and a figure, in a screen. The screen including the object displayed by the display 2A includes a screen called a lock screen, a screen called a home screen, and an application screen displayed during execution of an application, for example. The home screen may be called a desktop, standby screen, an idle screen, a standard screen, an application list screen, or a launcher screen. In the embodiments, the display 2A is configured to display an image of a preset character when the mobile terminal 1 is placed in the charging stand 100.

The touch screen 2B detects a contact or approach of a finger, a pen, a stylus pen, or the like to the touch screen 2B. The touch screen 2B is configured to detect positions or a position on the touch screen 2B which a plurality of fingers, a pen, a stylus pen, or the like is in contact with or approaches to. In the following description, positions or a position on the touch screen 2B which a plurality of fingers, a pen, a stylus pen, or the like is in contact with or approaches to and which is detected by the touch screen 2B is referred to as “detected position”. The touch screen 2B notifies the controller 10 of contact or approach of the fingers with or to the touch screen 2B and the detected position. The touch screen 2B may send the notification of the detected position to the controller 10, as the notification of the contact or approach thereof.

On the basis of at least one of contact or approach, a detected position, a change in detected position, the duration of the contact or approach, an interval between detections of the contact or approach, and the number of times of detection of the contact detected by the touch screen 2B, the controller 10 determines the classification of a gesture. The gesture represents finger operation made on the touch screen 2B. The gesture determined by the controller 10 via the touch screen 2B includes, but is not limited to, for example, a touch, a long touch, a release, a swipe, a tap, a double tap, a long tap, a drag, a flick, a pinch-in, and a pinch-out.

In the following description, one-finger gesture may be referred to as “single touch gesture”, and two-or-more-finger gesture may be referred to as “multi-touch gesture”. The multi-touch gesture includes, for example, pinch-in and pinch-out. A tap, flick, swipe, and the like performed by one finger are the single touch gesture, and a tap, flick, swipe, and the like performed by two or more fingers are the multi-touch gesture.

The controller 10 is operated in accordance with these gestures determined via the touch screen 2B. Thus, operation property of the touch screen 2B is achieved, allowing the user to intuitively use the touch screen 2B. Operation of the controller 10 performed in accordance with a determined gesture may differ depending on a screen displayed on the display 2A.

The touch screen 2B may employ any of detection methods using capacitance, a resistance film, surface acoustic wave, infrared light, load detection, and the like.

The home key 3A receives operation input by the user. Examples of operation on the home key 3A or the like include, but are not limited to, a click, a double click, a triple click, a push, a multi push, etc. The mobile terminal 1 may include a plurality of keys relating to other functions, in addition to the home key 3A.

The buzzer switch 3B receives operation for ringing a crime prevention buzzer. The buzzer switch 3B is operated, for example, by pulling the strap 30 connected to the buzzer switch 3B. When the strap 30 is pulled, a signal giving instructions to produce a warning sound is transmitted from a circuit connected to the buzzer switch 3B to the controller 10. The buzzer switch 3B is an example of an operation part.

The illuminance sensor 4 detects illuminance. The illuminance represents a value of the luminous flux incident on a unit area of a measurement surface of the illuminance sensor 4. The illuminance sensor 4 is used, for example, to adjust the brightness of the display 2A.

The proximity sensor 5 contactlessly detects the presence of a nearby object. The proximity sensor 5 includes a light-emitting element for emitting infrared light and a light receiving element for receiving reflected light from infrared light emitted from the light-emitting element. The illuminance sensor 4 and the proximity sensor 5 may be configured as one sensor.

The communication unit 6 performs wireless communication. A wireless communication standard supported by the communication unit 6 includes a cellular phone communication standard, such as 2G, 3G, 4G, and 5G, and a near field communication standard. The cellular phone communication standard includes, for example, Long Term Evolution (LTE), Wideband Code Division Multiple Access (W-CDMA) (trade mark), CDMA2000, personal digital cellular (PDC), Global System for Mobile Communications (GSM) (trade mark), Personal Handy-phone System (PHS), and the like. The near field communication standard includes, for example, Worldwide interoperability for Microwave Access (WiMAX) (trade mark), IEEE802.11, Bluetooth (trade mark), Infrared Data Association (IrDA), Near Field Communication (NFC) (trade mark), wireless personal area network (WPAN), and the like. The communication unit 6 may support one or a plurality of the communication standards described above. The communication unit 6 is an example of a communication module.

The receiver 7 outputs, as a sound, a sound signal output from the controller 10. The microphone 8 converts input user's voice or the like into a sound signal and transmits the sound signal to the controller 10.

The storage 9 stores a program and data. The storage 9 may be used as a work area for temporarily storing a result of a process made by the controller 10. The storage 9 may include any non-transitory storage medium, such as a semiconductor storage medium and a magnetic storage medium. The storage 9 may include a plurality of types of storage mediums. The storage 9 may include a combination of a storage medium, such as a memory card, an optical disk, or a magnetooptical disk, and a storage medium reader. The storage 9 may include a storage device, such as random access memory (RAM), used as a temporal storage area.

Programs stored in the storage 9 include an application executed in foreground or background, and a support program (not illustrated) for supporting the operation of the application. When the application is executed, for example, in foreground, a screen relating to the application is displayed on the display 2A. The support program includes, for example, an operating system (OS). The programs may be installed in the storage 9 via wireless communication made by the communication unit 6 or the non-transitory storage medium.

The storage 9 is configured to store a control program 9A, a home application 9B, setting data 9Z, and the like.

The control program 9A is configured to provide functions to enable processes relating to various operations of the mobile terminal 1. Functions provided by the control program 9A include a function for adjusting the brightness of the display 2A on the basis of a result of detection made by the illuminance sensor 4. Functions provided by the control program 9A include a function for disabling an operation performed on the touch screen 2B on the basis of a result of detection made by the proximity sensor 5. Functions provided by the control program 9A include a function for controlling the communication unit 6, the receiver 7, the microphone 8, and the like to achieve a phone call. Functions provided by the control program 9A include a function for controlling image capturing processes of the camera 12 and the camera 13. Functions provided by the control program 9A include a function for controlling communication with an external device connected via the connector 14. Functions provided by the control program 9A include a function for performing various control such as changing information displayed on the display 2A in accordance with a gesture determined on the basis of a result of detection made by the touch screen 2B. Functions provided by the control program 9A include a function for performing processing based on an actual location in accordance with a signal acquired by the GPS receiver 15.

The control program 9A is configured to provide a function for switching an operation mode of the mobile terminal from a first mode to a second mode when detecting placement of the mobile terminal 1 in the charging stand 100. The control program 9A is configured to detect the placement of the mobile terminal in the charging stand 100, for example, when power supply from the charging stand 100 is started. The first mode is a mode for controlling various operations of the mobile terminal when the mobile terminal is not placed in the charging stand 100. The second mode is a mode for controlling various operations of the mobile terminal 1 when the mobile terminal is placed in the charging stand 100.

The control program 9A is configured to provide a function for outputting a warning sound on the basis of the operation of the buzzer switch 3B in the first mode, and outputting no warning sound even though the buzzer switch 3B is operated in the second mode.

The control program 9A is configured to provide a function for performing pairing between the mobile terminal and the charging stand 100 when detecting the placement of the mobile terminal in the charging stand 100, and provide a function for switching the operation mode of the mobile terminal from the first mode to the second mode when the pairing is completed. The control program 9A uses Bluetooth (trade mark) to establish a near field communication connection with the charging stand 100, and the mobile terminal and the charging stand 100 are allowed to be paired.

The control program 9A is configured to provide a function for giving notification of a request for electrical charging when a distance between the mobile terminal and the charging stand 100 is not more than a predetermined distance. The control program 9A is configured to measure the value of received signal strength indicator (RSSI) of a radio wave emitted from the charging stand 100 to measure the distance between the mobile terminal and the charging stand 100. When the mobile terminal has a distance measuring sensor, the control program 9A may measure the distance between the mobile terminal and the charging stand 100.

In the first mode, the control program 9A is configured to provide a function for outputting a sound from the speaker 11 or the receiver 7 of the mobile terminal. In the second mode, the control program 9A is configured to provide a function for outputting a sound from the speaker 110 of the charging stand 100 in association with the home application. In the second mode, the control program 9A is configured to provide a function for causing the speaker 110 of the charging stand 100 to output a ringtone, voice during a call, alarm sound, or warning sound.

The home application 9B is configured to provide a function for controlling the operation of the mobile terminal 1 in the second mode in association with the control program 9A. For example, functions provided by the home application 9B include a function for notifying the mobile terminal MB1 and the mobile terminal MB2 on completion of switching of the operation mode of the mobile terminal from the first mode to the second mode, via the communication unit 6. The mobile terminal MB1 and the mobile terminal MB2 are previously set as a destination to which notification is to be given. The mobile terminal MB1 and the mobile terminal MB2 may be notified that, for example, electrical charge of the mobile terminal 1 is started or that a user of the mobile terminal 1 is home instead of notifying that the electrical charge is started.

For example, functions provided by the home application 9B include a function for causing the display 2A to display an image of a preset character when detecting the placement of the mobile terminal in the charging stand. The image of the character may be different between before and after switching from the first mode to the second mode.

For example, functions provided by the home application 9B include a function for giving notification of a message associated with preset time from the speaker 110 of the charging stand 100. For the message associated with preset time, a message having a desired content is freely set. Examples of the message associated with preset time include information given from a parent to a child, such as instructions about daily habits, for example, gargling and washing hands of a child who comes home, information about time to go to lesson, and parent's scheduled time to come home.

For example, functions provided by the home application 9B include a function for causing the camera 12 or the camera 13 to capture an image in accordance with instructions received from the mobile terminal MB1 or mobile terminal MB2 via the communication unit 6, and transmitting the captured image to the mobile terminal MB1 or the mobile terminal MB2 from which the instructions are transmitted, via the communication unit 6.

For example, functions provided by the home application 9B include a function for calculating a positional relationship between preset first and second positions and an actual location of the mobile terminal MB1 or mobile terminal MB2 on the basis of locational information received from the mobile terminal MB1 or the mobile terminal MB2 via the communication unit 6, generating a virtual image indicating the calculated positional relationship, and causing the display 2A to display the generated image. In an example of the first position and the second position, it is conceivable that the first position represents the position of home of a user (hereinafter, described as a child) of the mobile terminal 1 and a user (hereinafter, described as both parents) of the mobile terminal MB1 or the mobile terminal MB2, and the second position represents the position of companies where both parents work.

For example, functions provided by the home application 9B include a function for periodically receiving locational information from the mobile terminal MB1 or mobile terminal MB2, recalculating a positional relationship between the first and the second positions and an actual location of the mobile terminal MB1 or mobile terminal MB2 on the basis of the latest locational information every time locational information is received, and causing the display 2A to display an image updated on the basis of the recalculated positional relationship. For example, when the first mode is switched to the second mode, the mobile terminal MB1 or the mobile terminal MB2 receives notification transmitted from the mobile terminal 1, and thereby starts positional measurement and transmits location data to the mobile terminal 1.

For example, functions provided by the home application 9B include a function for recording, in the storage 9, locational information received from the mobile terminal MB1 or the mobile terminal MB2.

The setting data 9Z includes various setting information about the operation of the mobile terminal 1. The setting data 9Z includes authentication data 91, home application data 92, a notification setting table 93, group terminal data 94, and group terminal location data 95.

The authentication data 91 includes data, such as a profile referred to for pairing between the mobile terminal and the charging stand 100, and a passkey exchanged between the mobile terminal and the charging stand 100 during the pairing.

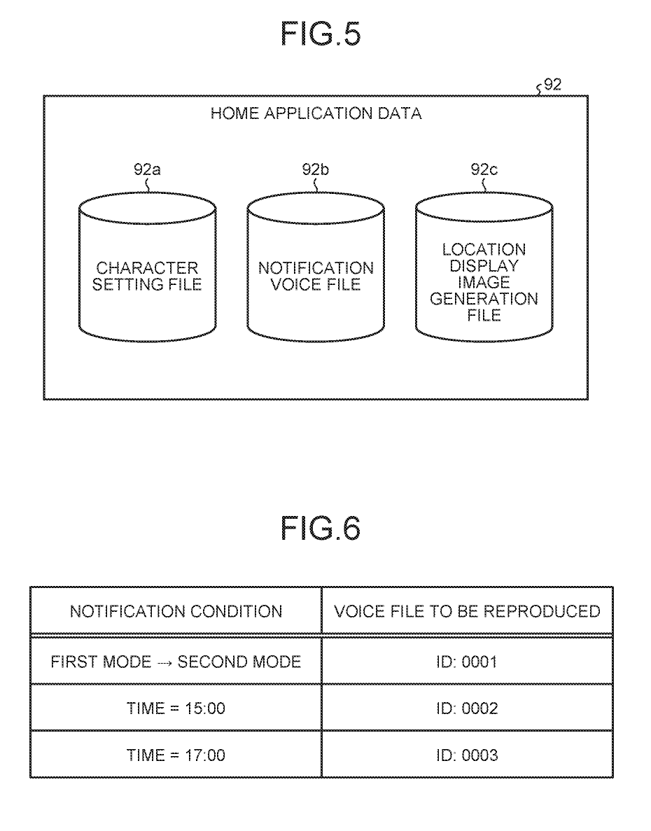

The home application data 92 is referred to in a process performed by the home application 9B. FIG. 5 is a diagram illustrating an overview of a configuration of the home application data according to an embodiment. As illustrated in FIG. 5, the home application data 92 includes a character setting file 92a, a notification voice file 92b, and a location display image generation file 92c. The character setting file 92a is a file in which image data of a character is set to be displayed on the display 2A when detecting placement of the mobile terminal in the charging stand. The notification voice file 92b is a file in which voice data for notification from the speaker 110 of the charging stand 100 is set. The location display image generation file 92c is a file in which data is set to be referred to for generating a virtual image indicating a positional relationship between preset first and second positions and an actual location of the mobile terminal MB1 or the mobile terminal MB2.

The notification setting table 93 is a table in which conditions for predetermined notifications from the speaker 110 of the charging stand 100 are set. FIG. 6 is an exemplary diagram of the notification setting table according to an embodiment. As illustrated in FIG. 6, in the notification setting table 93, an identifier of a voice file to be reproduced is associated with a notification condition. Examples of the notification condition include, but are not limited to, “completion of switching from the first mode to the second mode”, “the current time is 15:00”, “the current time is 17:00”, etc. As examples of the contents of a voice file corresponding to completion of switching from the first mode to the second mode, greeting voice messages for a child who comes home, such as “Welcome back” and “Please wash your hands” are conceivable. As an example of the contents of a voice file corresponding to a current time of 15:00, voice information for a child, such as “You may eat a snack in the refrigerator”, is conceivable. As an example of the contents of a voice file corresponding to a current time of 17:00, a voice of a reminder notification for a child, such as “It is time to go to cram school”, is conceivable. The notification setting table 93 is capable of having a voice file generated by recording a time-corresponding message, for example, by both parents via a predetermined user interface or the like.

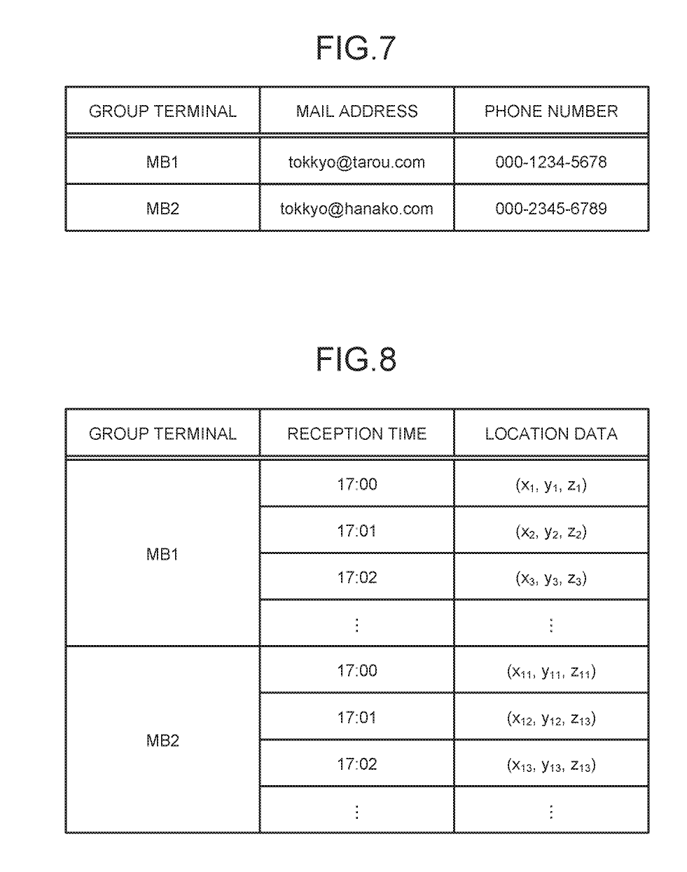

The group terminal data 94 is data about terminals previously set as a group to exchange data with the mobile terminal 1. As an example of group terminals, it is conceivable that the mobile terminal MB1 and the mobile terminal MB2 which are used by both parents of a child who uses the mobile terminal 1 are set as the group terminals. For example, FIG. 7 is an exemplary table of a group terminal data according to an embodiment. As illustrated in FIG. 7, the group terminal data 94 is configured to associate a mail address with a phone number for each group terminal.

The group terminal location data 95 is location data received from the group terminals. FIG. 8 is an exemplary table of the group terminal location data according to an embodiment. As illustrated in FIG. 8, the group terminal location data 95 is configured to associate location data reception time with location data received at the reception time for each group terminal.

The mobile terminal 1 may cooperate with a cloud storage via the communication unit 6 to access a file and data stored in the cloud storage. The cloud storage may partially or wholly store programs and data stored in the storage 9.

The controller 10 includes a calculation device. Examples of the calculation device include, but are not limited to, a central processing unit (CPU), a system-on-a-chip (SoC), a micro control unit (MCU), a Field-Programmable Gate Array (FPGA), a co-processor, etc. The controller 10 integrally controls the operation of the mobile terminal 1 to enable various functions.

Specifically, the controller 10 executes a command contained in a program stored in the storage 9 while referring to data stored in the storage 9 if necessary. Then, the controller 10 controls function modules in accordance with the data and the command and enables various functions. Examples of the function modules include, but are not limited to, the display 2A, the communication unit 6, the microphone 8, the speaker 11, the GPS receiver 15, etc. The controller 10 may change control depending on a result of the detection made by detectors. Examples of the detectors include, but are not limited to, the touch screen 2B, the home key 3A, the illuminance sensor 4, the proximity sensor 5, the microphone 8, the camera 12, the camera 13, etc.

The controller 10 executes the control program 9A to enable various control relating to the operation of the mobile terminal 1. For example, the controller 10 enables processing for adjusting the brightness of the display 2A, on the basis of a result of the detection made by the illuminance sensor 4. For example, the controller 10 enables processing for disabling an operation on the touch screen 2B on the basis of a result of the detection made by the proximity sensor 5, owing to the function provided by the control program 9A. For example, the controller 10 controls the communication unit 6, the receiver 7, the microphone 8, and the like to enable processing for achieving a phone call. For example, the controller 10 enables processing for controlling image capturing processes of the camera 12 and the camera 13. For example, the controller 10 enables processing for controlling communication with an external device connected via the connector 14. For example, the controller 10 enables processing for performing various control such as changing information displayed on the display 2A in accordance with a gesture determined on the basis of a result of the detection made by the touch screen 2B. For example, the controller 10 enables processing based on an actual location in accordance with a signal acquired by the GPS receiver 15.

The controller 10 executes the control program 9A to enable processing for switching the operation mode of the mobile terminal from the first mode to the second mode when detecting placement of the mobile terminal 1 in the charging stand 100. The controller 10 is configured to detect the placement of the mobile terminal in the charging stand 100, for example, when power supply from the charging stand 100 is started.

The controller 10 also executes the control program 9A to enable processing for performing pairing between the mobile terminal 1 and the charging stand 100 when detecting the placement of the mobile terminal 1 in the charging stand 100, and switching the operation mode of the mobile terminal from the first mode to the second mode when the pairing is completed.

The controller 10 executes the control program 9A and the home application to enable processing for outputting a warning sound on the basis of the operation of the buzzer switch in the first mode, and outputting no warning sound even though the buzzer switch is operated in the second mode. For example, in the second mode, the controller 10 controls the operation of the buzzer switch 3B to remove a signal output from a circuit connected to the buzzer switch to output no warning sound.

The controller 10 executes the control program 9A to enable processing for giving notification of a request for electrical charging when the distance between the mobile terminal and the charging stand 100 is not more than a predetermined distance. The controller 10 measures, for example, the value of received signal strength indicator of a radio wave emitted from the charging stand 100 to measure the distance between the mobile terminal and the charging stand 100.

The controller 10 executes the control program 9A and the home application 9B to enable processing for outputting a sound from the speaker 11 or the receiver 7 of the mobile terminal in the first mode, and outputting a sound from the speaker 110 of the charging stand 100 in association with the home application in the second mode.

The controller 10 executes the control program 9A and the home application 9B to enable processing for notifying the mobile terminal MB1 and the mobile terminal MB2 on completion of switching of the operation mode of the mobile terminal from the first mode to the second mode, via the communication unit 6. The mobile terminal MB1 and the mobile terminal MB2 are previously set as a destination to which notification is to be given. The mobile terminal MB1 and the mobile terminal MB2 may be notified that, for example, electrical charge of the mobile terminal 1 is started or that the user of the mobile terminal 1 is home instead of notifying that the electrical charge is started.

The controller 10 executes the control program 9A and the home application 9B to enable processing for giving notification of a message associated with preset time from the speaker 110 of the charging stand 100.

The controller 10 executes the control program 9A and the home application 9B to enable processing for causing the camera 12 or the camera 13 to capture an image in accordance with instructions received from the mobile terminal MB1 or the mobile terminal MB2 via the communication unit 6, and transmitting the captured image to the mobile terminal MB1 or mobile terminal MB2 from which the instructions are transmitted, via the communication unit 6.

The controller 10 executes the control program 9A and the home application 9B to enable processing for calculating a positional relationship between the preset first and second positions and an actual location of the mobile terminal MB1 or mobile terminal MB2 on the basis of locational information received from the mobile terminal MB1 or mobile terminal MB2 via the communication unit 6, generating a virtual image indicating the calculated positional relationship, and causing the display 2A to display the generated image.

The controller 10 executes the control program 9A and the home application 9B to enable processing for periodically receiving locational information from the mobile terminal MB1 or mobile terminal MB2, recalculating a positional relationship between the first and the second positions and an actual location of the mobile terminal MB1 or mobile terminal MB2 on the basis of the latest locational information every time locational information is received, and causing the display 2A to display an image updated on the basis of the recalculated positional relationship.

The controller 10 executes the control program 9A and the home application 9B to enable processing for recording, in the storage 9, locational information received from the mobile terminal MB1 or the mobile terminal MB2.

The speaker 11 outputs, as a sound, a sound signal output from the controller 10. The speaker 11 is used, for example, to output a ringtone and music. One of the receiver 7 and the speaker 11 may also have the function of the other.

The camera 12 and the camera 13 each convert a captured image to an electric signal. The camera 12 is the in-camera for capturing an image of an object facing the display 2A. The camera 13 is the out-camera for capturing an image of an object facing the opposite side of the display 2A. The camera 12 and the camera 13 may be mounted to the mobile terminal 1 as a camera unit which is functionally and physically integrated and used by being switched between the in-camera and the out-camera.

The connector 14 is a terminal for connecting another device. The connector 14 may be a versatile terminal, such as universal serial bus (USB), High-Definition Multimedia Interface (HDMI) (trade mark), Mobile High-definition Link (MHL), Light Peak, Thunderbolt (trade mark), Local Area Network connector (LAN) connector, or earphone-microphone connector. The connector 14 may be a dedicatedly designed terminal, such as Dock connector. Examples of a device connected to the connector 14 include, but are not limited to, a battery charger, an external storage, a speaker, a communication device, an information processing device, etc.

The GPS receiver 15 is configured to receive a radio signal of a predetermined frequency band from a GPS satellite. The GPS receiver demodulates a received radio signal and transmits the demodulated signal to the controller 10.

The battery 16 stores power applied from the charging stand 100.

The mobile terminal 1 may include an acceleration sensor. The acceleration sensor is configured to detect the direction and the magnitude of acceleration applied to, for example, a mobile terminal 1. The acceleration sensor may adopt a three-axis acceleration sensor for detecting accelerations in X-, Y-, and Z-axis directions. The acceleration sensor may use piezoresistance, capacitance, piezoelectric element (piezoelectricity), thermal micro electro mechanical systems (MEMS), a servo mechanism for returning a moved movable coil to the original position of the coil using a feedback current, a strain gauge, or the like. The acceleration sensor transmits a detection result to the controller. The controller 10 enables performance of various control on the basis of the results of the detection made by the acceleration sensor.

The mobile terminal 1 may include a direction sensor. The direction sensor is configured to detect the direction of the earth's magnetic field. The direction sensor transmits a detection result to the controller 10. The controller 10 enables performance of various control on the basis of a result of the detection made by the direction sensor.

The mobile terminal 1 may include an angular velocity sensor. The angular velocity sensor is configured to detect the angular speed of the mobile terminal 1. The angular velocity sensor transmits a detection result to the controller 10. The controller 10 enables performance of various control on the basis of a result of the detection made by the angular velocity sensor.

The controller 10 is capable of not only using individual results of the detection made by acceleration sensor, the direction sensor, and the angular velocity sensor, but also using a combination of results of the detection made by acceleration sensor, the direction sensor, and the angular velocity sensor.

The mobile terminal 1 may include an atmospheric pressure sensor. The atmospheric pressure sensor is configured to detect atmospheric pressure acting on the mobile terminal 1. A result of the detection made by the atmospheric pressure sensor may include a variation in atmospheric pressure per unit time. The variation in atmospheric pressure may have an absolute value or a value obtained by accumulating scalar quantities. The unit time may be set to a desired time period. The atmospheric pressure sensor transmits a detection result to the controller 10.

The mobile terminal 1 may include a vibrator. The vibrator partially or wholly vibrates the mobile terminal 1. The vibrator includes, for example, a piezoelectric element or an eccentric motor to generate vibration. The mobile terminal 1 may include a temperature sensor, a humidity sensor, a pressure sensor, or the like in addition to the sensors described above. The function modules, such as the battery 16, normally used to maintain the function of the mobile terminal 1, and the detectors normally used to enable control of the mobile terminal 1 are mounted to the mobile terminal 1.

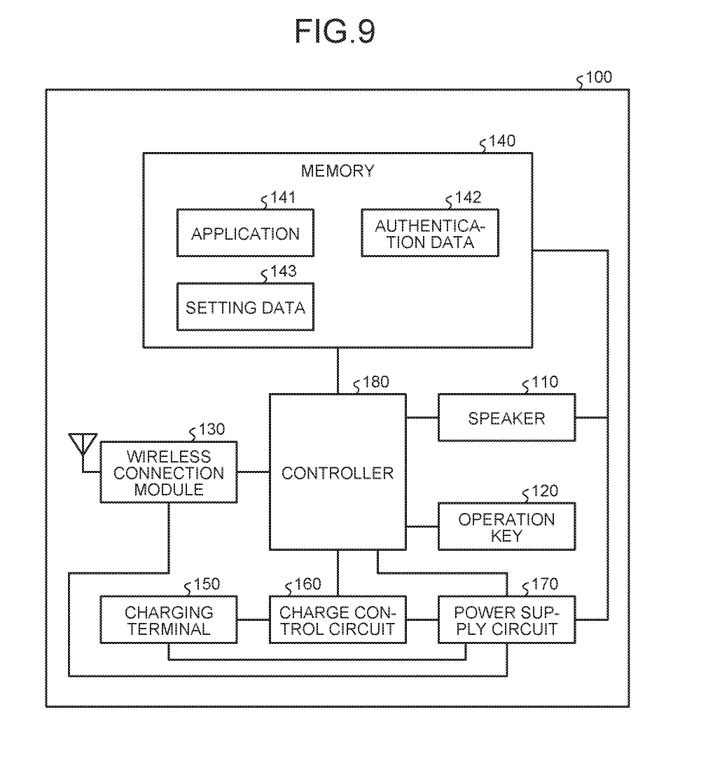

FIG. 9 is an exemplary block diagram of a functional configuration of a charging stand 100 according to an embodiment. As illustrated in FIG. 9, the charging stand 100 includes the speaker 110, an operation key 120, a wireless connection module 130, a memory 140, a charging terminal 150, a charge control circuit 160, a power supply circuit 170, and a controller 180.

The speaker 110 outputs a sound or a voice respectively corresponding to a sound signal or a voice signal transmitted from a paired mobile terminal 1.

The operation key 120 receives various operations. For example, the operation key 120 receives operation for switching the wireless connection module 130 to a state allowing pairing with the mobile terminal 1.

The wireless connection module 130 establishes a near field communication connection with the mobile terminal 1.

The memory 140 stores programs and data for performing processing relating to various operations of the charging stand 100. The memory 140 stores an application 141, authentication data 142, and setting data 143.

The application 141 is configured to provide a function for performing processing relating to various operations of the charging stand 100. Functions provided by the application 141 include, for example, a function for performing pairing with the mobile terminal 1 via the wireless connection module 130. The application 141 is configured to provide a function for causing the speaker 110 to output a sound signal or the like transmitted from the mobile terminal 1.

The authentication data 142 includes data, such as a profile referred to for pairing with the mobile terminal 1, and a passkey exchanged with the mobile terminal 1 during the pairing.

The setting data 143 includes data referred to by the application 141 in processing relating to various operations of the charging stand 100.

The charging terminal 150 supplies power to the battery 16 of the mobile terminal 1. The charge control circuit 160 includes a microprocessor to control power supply to the battery 16 performed via the charging terminal 150. The power supply circuit 170 receives power supplied from an AC power supply (commercial AC power supply) and supplies the power to respective portions of the charging stand 100.

The controller 180 includes a calculation device. Examples of the calculation device include, but are not limited to, a central processing unit (CPU), a system-on-a-chip (SoC), a micro control unit (MCU), a Field-Programmable Gate Array (FPGA), a co-processor, etc. The controller 180 integrally controls the operation of the charging stand 100 to enable various functions.

The controller 180 executes the application 141 to enable pairing with the mobile terminal 1. The controller 180 executes the application 141 to enable processing for causing the speaker 110 to output a sound signal or the like transmitted from the mobile terminal 1.

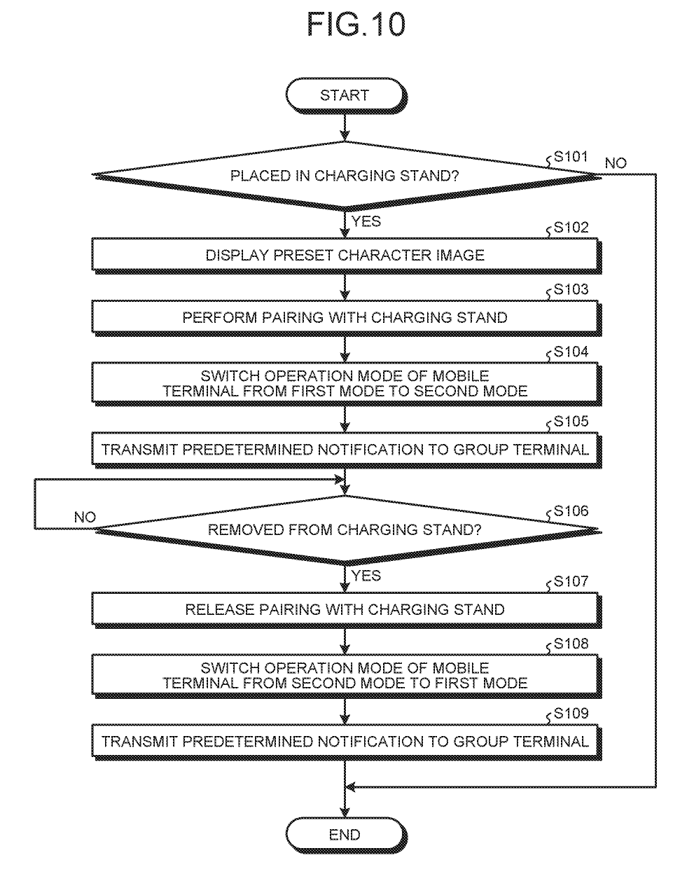

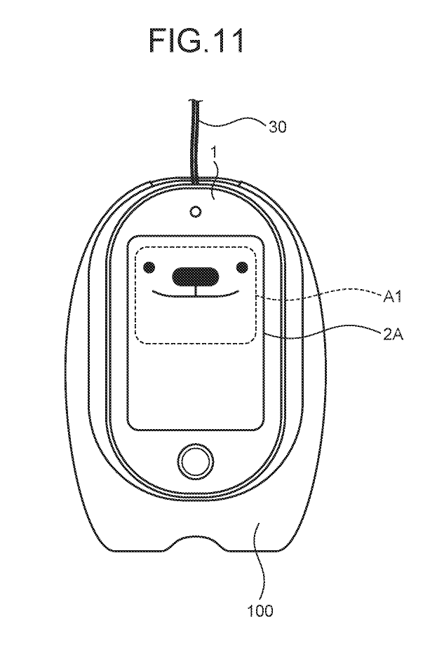

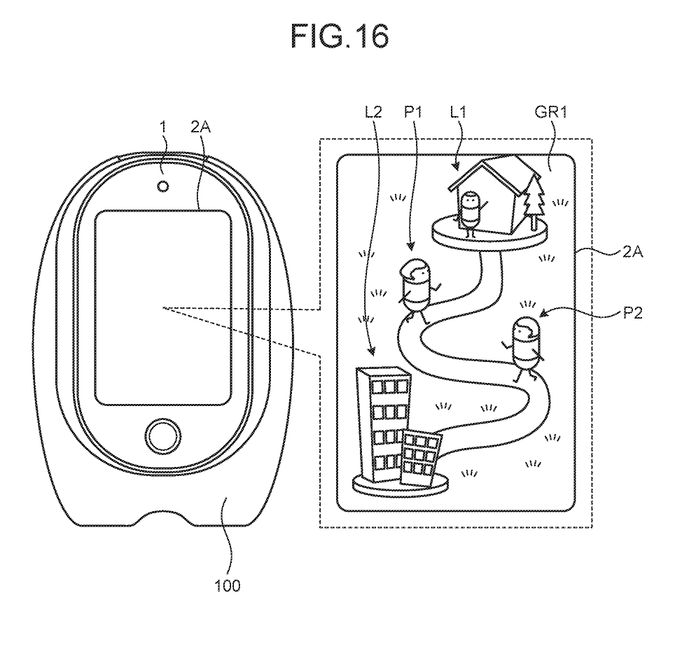

FIGS. 10, 12 to 15, and 17 to 19 are exemplary flowcharts illustrating processes performed by the mobile terminal 1 according to an embodiment. FIG. 11 is a diagram illustrating exemplary display of a character image according to an embodiment. FIG. 16 is a diagram illustrating exemplary display of a location display image according to an embodiment. Group terminals in the following description correspond to the mobile terminal MB1 and the mobile terminal MB2. The process of FIG. 10 is enabled by executing a control program and the home application 9B by the controller 10.

FIG. 10 illustrates a process performed by the mobile terminal 1 detecting placement or the like thereof in the charging stand 100. As illustrated in FIG. 10, the controller 10 determines whether the mobile terminal 1 is placed in the charging stand 100 (step S101).

If the mobile terminal 1 is determined to be placed in the charging stand 100 (step S101, Yes), the controller 10 displays an image Al of a preset character on the display 2A, as illustrated in FIG. 11 (step S102).

The controller 10 performs pairing with the charging stand (step S103). After completion of pairing, the controller 10 switches the operation mode of the mobile terminal from the first mode to the second mode (step S104).

After completion of switching the mode, the controller 10 transmits predetermined notification to a group terminal (step S105).

The controller 10 determines whether the mobile terminal 1 is removed from the charging stand 100 (step S106).

If the mobile terminal 1 is determined to be installed in the charging stand 100 (step S106, No), the controller 10 repeats the determination in step S106.

Meanwhile, if the mobile terminal 1 is determined to be removed from the charging stand 100 (step S106, Yes), the controller 10 releases the pairing with the charging stand 100 (step S107).

After releasing the pairing, the controller 10 switches the operation mode of the mobile terminal from the second mode to the first mode (step S108).

After completion of switching the mode, the controller 10 transmits predetermined notification to the group terminal and finishes the process of FIG. 10 (step S109).

In step S101 described above, if the mobile terminal 1 is determined to be not placed in the charging stand 100 (step S101, No), the controller 10 finishes the process of FIG. 10.

In step S105 described above, the predetermined notification transmitted to the group terminal may be notification of starting electrical charge of the mobile terminal 1 or notification of coming home of the user of the mobile terminal 1 instead of notification of starting the electrical charge.

In step S107 described above, pairing may be released immediately after removal of the mobile terminal 1 from the charging stand 100 is detected or after a predetermined time passes from when removal of the mobile terminal 1 from the charging stand 100 is detected.

In step S105 described above, the predetermined notification transmitted to the group terminal may be notification of removal of the mobile terminal 1 from the charging stand 100 or notification of movement of the user of the mobile terminal 1 carrying about the mobile terminal 1 instead of notification of removal of the mobile terminal 1 from the charging stand 100.

In the embodiment described above, for example, a parent (parent or guardian of the user of the mobile terminal 1) being a user of a group terminal is allowed to assume the behavior of his/her child being the user of the mobile terminal 1.

A procedure corresponding to step S102 described above may be performed after a procedure corresponding to step S103 described above or after a procedure corresponding to step S104 described above.

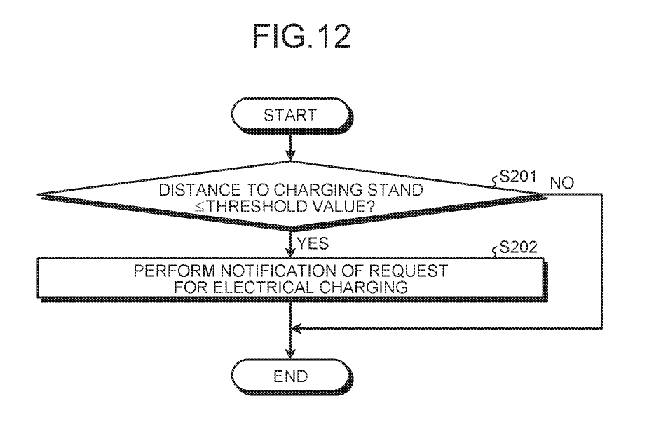

FIG. 12 illustrates a process performed by the mobile terminal 1 detecting approaching thereof to the charging stand 100. As illustrated in FIG. 12, the controller 10 determines whether a distance to the charging stand 100 is not more than a threshold value (step S201).

If the distance to the charging stand 100 is determined not more than the threshold value (step S201, Yes), the controller 10 performs notification of a request for electrical charging (step S202) and finishes the process of FIG. 12.

Meanwhile, if the distance to the charging stand 100 is determined not less than the threshold value (step S201, No), the controller 10 finishes the process of FIG. 12.

In step S202 described above, the notification of a request for electrical charging includes image notification or voice notification. In the case of the image notification, an image having a message for electrical charge may be displayed over the display 2A or a message for electrical charge may be displayed in a banner displayed on the display 2A. In the case of the voice notification, predetermined voice notification may be given beforehand.

In the embodiment described above, for example, the child being the user of the mobile terminal 1 is less likely to forget to place the mobile terminal 1 in the charging stand when the child comes home.

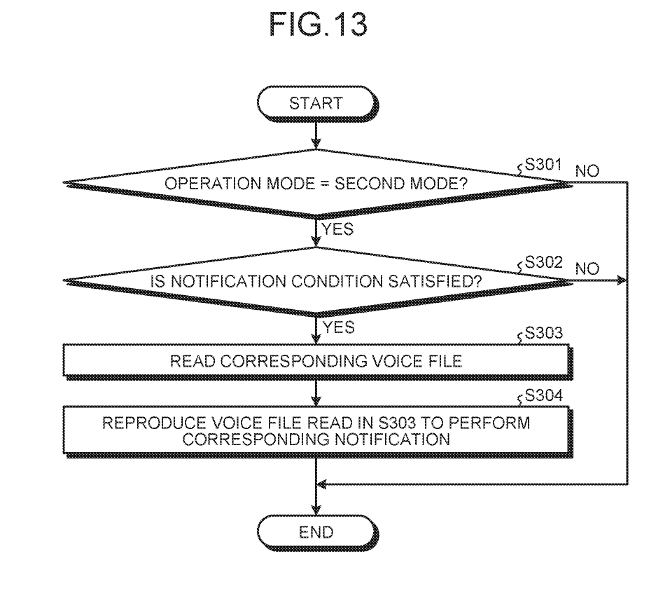

FIG. 13 illustrates a process of notifying of a message according to a preset time by the mobile terminal 1 in the second mode. As illustrated in FIG. 13, the controller 10 determines whether the operation mode is the second mode (step S301).

If the operation mode is determined to be the second mode (step S301, Yes), the controller 10 refers to the notification setting table 93 to determine whether a notification condition is satisfied (step S302).

If the notification condition is determined to be satisfied (step S302, Yes), the controller 10 reads a corresponding voice file from the home application data 92 stored in the storage 9 (step S303).

The controller 10 reproduces the voice file read in step S303 to perform corresponding notification (step S304) and finishes the process of FIG. 13. The controller 10 may perform predetermined notification from the speaker 110 of the charging stand 100. The controller 10 may transmit the voice file from the mobile terminal 1 to the charging stand 100 via the wireless connection module 130, and the controller 180 of the charging stand 100 may execute the application 141, reproducing the voice file received from the mobile terminal 1, outputting the corresponding notification from the speaker 110.

In step S302 described above, if the notification condition is determined to be not satisfied (step S302, No), the controller 10 finishes the process of FIG. 13.

In step S301 described above, if the operation mode is determined to be not the second mode (step S301, No), the controller 10 finishes the process of FIG. 13.

In the embodiment described above, for example, the child being the user of the mobile terminal 1 is less likely to forget his/her schedule after the child comes home.

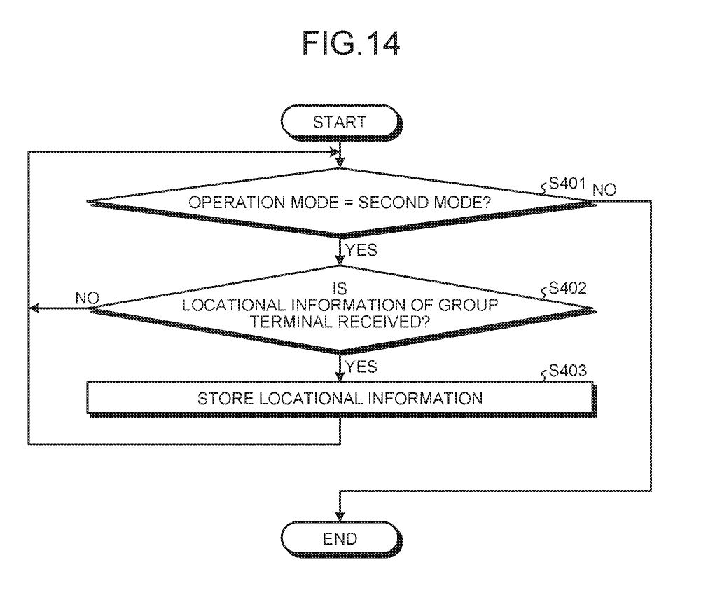

FIG. 14 illustrates a process of recording locational information of a group terminal by the mobile terminal 1 in the second mode. As illustrated in FIG. 14, the controller 10 determines whether the operation mode is the second mode (step S401).

If the operation mode is determined to be the second mode (step S401, Yes), the controller 10 determines whether the locational information of the group terminal is received (step S402).

If the locational information of the group terminal is determined to be received (step S402, Yes), the controller 10 stores the locational information of the group terminal in the storage 9 (step S403) and returns to the determination process in step S401 described above.

Meanwhile, if no locational information of the group terminal is determined to be received (step S402, No), the controller 10 returns to the determination process in step S401 described above.

In step S401 described above, if the operation mode is determined to be not the second mode (step S401, No), the controller 10 finishes the process of FIG. 14.

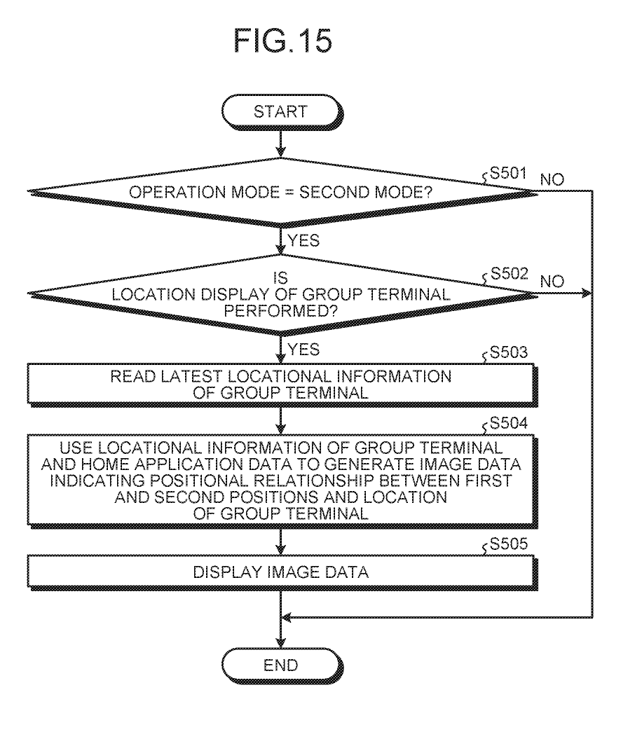

FIG. 15 illustrates a process of displaying an image indicating a location of a group terminal by the mobile terminal 1 in the second mode. As illustrated in FIG. 15, the controller 10 determines whether the operation mode is the second mode (step S501).

If the operation mode is determined to be the second mode (step S501, Yes), the controller 10 determines whether to perform location display of the group terminal (step S502).

If performance of the location display of the group terminal is determined (step S502, Yes), the controller 10 reads the latest locational information of the group terminal from the storage 9 (step S503).

The controller 10 uses the locational information of the group terminal read in step S503 and the home application data 92 (location display image generation file 92c) to generate image data indicating a positional relationship between the first and second positions and the location of the group terminal (step S504).

The controller 10 displays the image data (see FIG. 16) generated in step S504 on the display 2A (step S505) and finishes the process of FIG. 15. As illustrated in FIG. 16, when the mobile terminal 1 is placed in the charging stand 100 in the second mode, for example, an image GR1 is displayed on the display 2A. The image GR1 indicates a position L1 of home corresponding to the first position, companies L2 where both parents work, corresponding to the second position, actual locations P1 and P2 of both parents corresponding to the locations of the group terminals.

In step S502 described above, if no performance of the location display of the group terminal is determined (step S502, No), the controller 10 finishes the process of FIG. 15.

In step S501 described above, if the operation mode is determined to be not the second mode (step S501, No), the controller 10 finishes the process of FIG. 15.

In step S502, in the mobile terminal 1, whether to perform location display of the group terminal may be determined, for example, on the basis of presence/absence of child's operation to make instructions to perform location display of the group terminal or may be automatically determined on the basis of preset time (e.g., when both parents come home). The presence/absence of the child's operation may be detected on the basis of contact on a screen displayed on the display 2A, through the touch screen 2B. When the mobile terminal 1 includes a voice recognition function, instead of the detection of operation on the screen, child's voice input from the microphone 8 may be recognized to determine whether instructions are given to perform the location display of the group terminal.

In the embodiment described above, for example, the child being the user of the mobile terminal 1 can intuitively know where his/her parent or guardian being the user of a group terminal is located between his/her company and home, and the child can feel relieved.

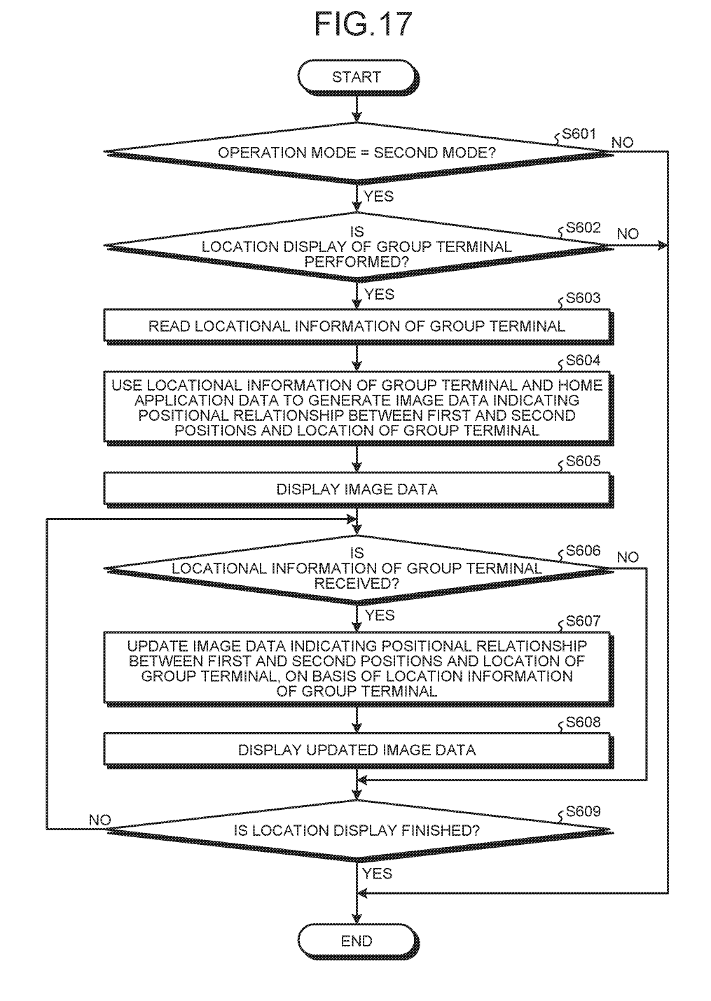

FIG. 17 illustrates a process in which the mobile terminal 1 updates an image indicating a location of a group terminal in the process of FIG. 15 described above. The process of FIG. 17 is different from the process of FIG. 15 in steps S606 to S609.

As illustrated in FIG. 17, the mobile terminal 1 determines whether the operation mode is the second mode (step S601).

If the operation mode is determined to be the second mode (step S601, Yes), the controller 10 determines whether to perform location display of the group terminal (step S602).

If performance of the location display of the group terminal is determined (step S602, Yes), the controller 10 reads the latest locational information of the group terminal from the storage 9 (step S603).

The controller 10 uses the locational information of the group terminal read in step S603 and the home application data 92 (location display image generation file 92c) to generate image data indicating a positional relationship between the first and second positions and the location of the group terminal (step S604).

The controller 10 displays the image data (see FIG. 16) generated in step S604 on the display 2A (step S605).

After displaying the image data, the controller 10 determines whether locational information of the group terminal is received (step S606).

If the locational information of the group terminal is determined to be received (step S606, Yes), the controller 10 updates the image data indicating the positional relationship between the first and second positions and the location of the group terminal, on the basis of the received location of the group terminal (step S607).

The controller 10 displays the image data updated in step S607 on the display 2A (step S608).

After updating the image, the controller 10 determines whether to finish the location display (step S609). The determination of finish of the location display may be made on the basis of the presence/absence of the child's operation or the presence/absence of an event, such as reception of a message or a call.

If continuation of the location display is determined (step S609, No), the controller 10 returns to the determination process in step S606 described above.

If finish of the location display is determined (step S609, Yes), the controller 10 finishes the process of FIG. 17.

In step S606 described above, if no locational information of the group terminal is determined to be received (step S606, No), the process proceeds to the determination process in step S609.

In step S602 described above, if performance of no location display of the group terminal is determined (step S602, No), the controller 10 finishes the process of FIG. 17.

In step S601 described above, if the operation mode is determined to be not the second mode (step S601, No), the controller 10 finishes the process of FIG. 17.

In step S606 described above, the controller 10 may perform storing locational information received from the group terminal simultaneously with the procedure of step S606 and in the background of the procedure of step S606.

In the embodiment described above, for example, the child being the user of the mobile terminal 1 can know constantly updated actual locations of his/her parent or guardian being the user of a group terminal, between his/her company and home, and the child can feel relieved knowing that his/her parent or guardian is on the way home.

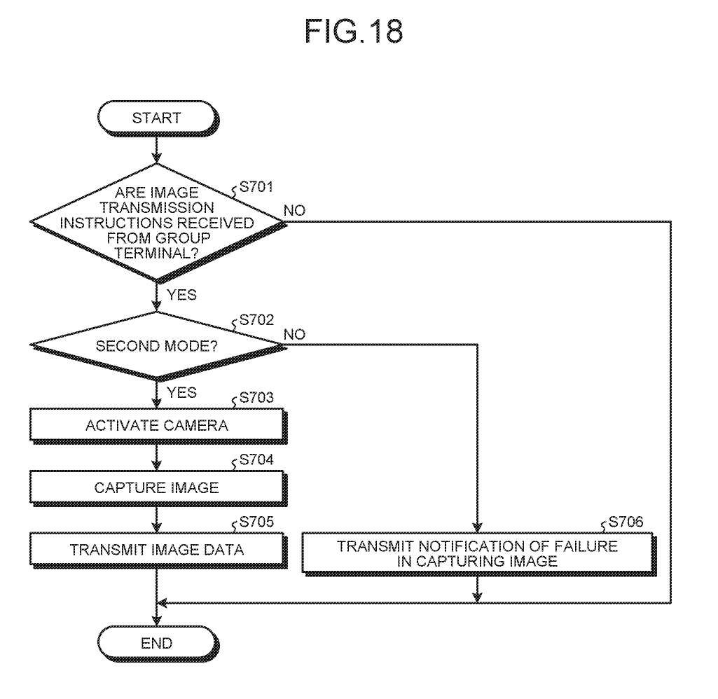

FIG. 18 illustrates a process of transmitting a captured image by the mobile terminal 1 in accordance with a request from a group terminal in the second mode. As illustrated in FIG. 18, the controller 10 determines whether image transmission instructions are received from the group terminal (step S701).

If the image transmission instructions are determined to be received from the group terminal (step S701, Yes), the controller 10 determines whether the operation mode is the second mode (step S702).

If the operation mode is determined to be the second mode (step S702, Yes), the controller 10 activates at least one of the camera 12 and the camera 13 (step S703).

The controller 10 captures an image by using the camera activated in step S703 (step S704).

The controller 10 transmits image data of the image captured in step S704 to the group terminal (step S705).

In step S702 described above, if the operation mode is determined to be not the second mode (step S702, No), the controller 10 transmits notification of failure in capturing the image (step S706) and finishes the process of FIG. 18.

If no image transmission instructions are determined to be received from the group terminal (step S701, No), the controller 10 finishes the process of FIG. 18.

In step S705 described above, the mobile terminal may transmit a captured image only to the group terminal from which the image transmission instructions are transmitted or may transmit the image to all terminals registered as the group terminals.

In the embodiment described above, for example, a parent or guardian being the user of a group terminal can watch the image to confirm the behavior of his/her child being the user of the mobile terminal 1 at home, and the parent or guardian can feel relieved.

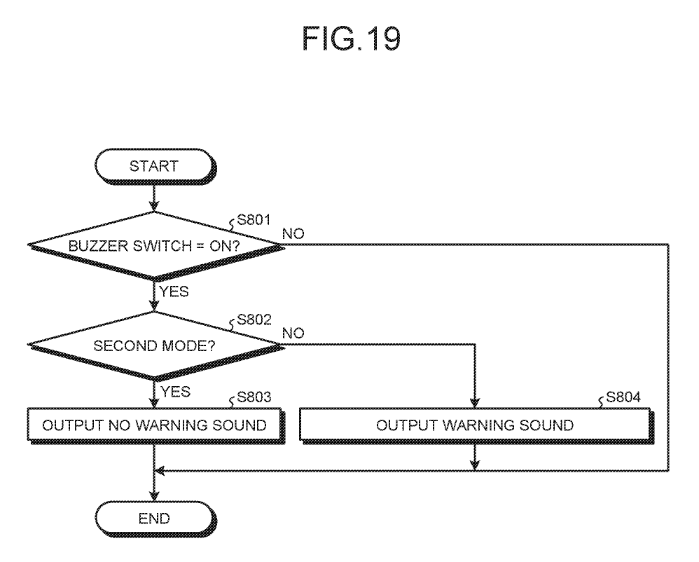

FIG. 19 illustrates a process performed by the mobile terminal 1 in accordance with operation to the buzzer switch 3B. As illustrated in FIG. 19, the controller 10 determines whether the buzzer switch 3B is operated (step S801).

If the buzzer switch 3B is determined to be operated (step S801, Yes), the controller 10 determines whether the operation mode is the second mode (step S802).

If the operation mode is determined to be the second mode (step S802, Yes), the controller 10 finishes the process of FIG. 19, without outputting a warning sound (step S803).

If the operation mode is determined to be not the second mode (step S802, No), the controller 10 outputs a warning sound (step S804) and finishes the process of FIG. 19.

In step S801 described above, if the buzzer switch 3B is determined to be not operated (step S801, No), the controller 10 finishes the process of FIG. 19.

Various functions of the mobile terminal 1 as described in the above embodiments are capable of improving user's convenience, from the viewpoint of a parent or guardian taking care of his/her little child or the like and from the viewpoints of the child taken care of by the parent or guardian.

In the above embodiments, for example, the mobile terminal 1 varies in watching function depending on the situation of a child as the user. For example, a child having the mobile terminal 1 in the second mode is less likely to be in such a dangerous situation as requiring the output of a warning sound. Thus, in the second mode, operation of the buzzer switch 3B may provide another function without outputting warning sound. Examples of the other functions include, but are not limited to, incoming response, switching characters to be displayed, turning off notification voice, etc.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal comprising:
an operation part; a communication unit; a display; a speaker; a receiver; and a controller,
wherein the controller is configured to:
switch an operation mode of the mobile terminal from a first mode to a second mode, if detecting placement of the mobile terminal in a charging stand,
output a warning sound on the basis of operation from the operation part in the first mode, and
output no warning sound even though receiving operation from the operation part in the second mode.

2. The mobile terminal according to claim 1, wherein
the controller
is configured to detect placement of the mobile terminal in the charging stand, when power supply from the charging stand is started.

3. The mobile terminal according to claim 1, wherein
the controller
is configured to perform pairing with the charging stand if detecting placement of the mobile terminal in the charging stand, and switch the operation mode of the mobile terminal from the first mode to the second mode after completion of pairing.

4. The mobile terminal according to claim 1, wherein
the controller
is configured to perform notification of a request for electrical charging, if a distance between the mobile terminal and the charging stand is not more than a predetermined distance.

5. The mobile terminal according to claim 1, wherein
the controller
is configured to notify other terminal of completion of switching from the first mode to the second mode, via the communication unit, and the other terminal is previously set as a destination to which notification is to be given.

6. The mobile terminal according to claim 1, wherein
the controller
is configured to cause the display to display a preset image, if detecting placement of the mobile terminal in the charging stand.

7. The mobile terminal according to claim 1, wherein
the controller
is configured to perform output of a sound from the speaker or the receiver, in the first mode, and
is configured to perform output of a sound from a speaker included in the charging stand, in the second mode.

8. The mobile terminal according to claim 7, wherein
the controller
is configured to cause the speaker included in the charging stand to output a ringtone, voice during a call, or an alarm sound, in the second mode.

9. The mobile terminal according to claim 1, wherein
the controller
is configured to perform notification of a message associated with preset time from a speaker included in a charging stand, in the second mode.

10. The mobile terminal according to claim 1, further comprising
an imager,
wherein the controller
is configured to cause the imager to capture an image in accordance with instructions received from other terminal via the communication unit to transmit the captured image to the other terminal from which the instructions are transmitted, via the communication unit, in the second mode.

11. The mobile terminal according to claim 1, wherein
the controller
is configured to perform calculation of a positional relationship between preset first and second positions and an actual location of other terminal, on the basis of locational information received from the other terminal via the communication unit to generate a virtual image indicating the calculated positional relationship, and is configured to cause the display to display the generated image, in the second mode.

12. The mobile terminal according to claim 10, wherein
the controller
is configured to perform periodical reception of the locational information from the other terminal to recalculate the positional relationship on the basis of the latest locational information every time the locational information is received, and is configured to cause the display to display the image updated on the basis of the recalculated positional relationship, in the second mode.

13. A system comprising:
a mobile terminal; a charging stand; and other terminal,
wherein the mobile terminal includes:
a communication unit; and a controller,
the controller
is configured to perform notification of detection of placement of the mobile terminal in the charging stand, to the other terminal via the communication unit.
